(19) United States
(12) Patent Application Publication
(10) Pub. No.: US 2012/0021728 A1
(43) Pub. Date: Jan. 26, 2012

(54) WIRELESS DIRECTORY UNIT AND SYSTEM WITH CDMA TRANSFER AND SIM STORAGE METHOD

(76) Inventor: Heather Alisha Davis, Newton Falls, OH (US)

(21) Appl. No.: 12/531,307

(22) PCT Filed: Mar. 14, 2008
(86) PCT No.: PCT/US08/57169

§ 371 Date: May 25, 2011

Related U.S. Application Data
(60) Provisional application No. 60/906,772, filed on Mar. 14, 2007.

(51) Int. Cl. H04W 4/00

(52) U.S. Cl. 455/414.1

(57) ABSTRACT

A wireless directory device and system with method that can operate alone, or can accompany a cellular/mobile communications device. In any location it will quickly locate telephone number and/or address listings including residential, business, cellular, government, local, and any other types of listings provided by a telecommunication service provider. Users are able to locate and store a single listing, or an entire directory database of listings, for any geographical areas in the world. SIM card storage and GPS enable around the clock connection to the providers' databases instantly, regardless of changes of region caused by travel.

### CROSS-REFERENCE TO RELATED APPLICATIONS

This application claims the benefit of U.S. Provisional Patent Application No. 60/679,153, filed Mar. 14, 2008, by inventor Heather Alisha Davis.

### BACKGROUND OF THE INVENTION

There is a need for a wireless phone directory device that is intended to operate alone, or to accompany the average telephone operated by a cellular system. This is for any place in which it is necessary to quickly locate telephone number and/or address listings including residential, business, cellular, government, local, and any other types of listings provided by a telecommunication service provider. It's desirable for users to be able to locate and store a single listing, or entire directory database of listings, for any geographical areas in the world. Around the clock connection to the providers' databases is desired, especially if established instantly regardless of changes of region caused by travel.

### BRIEF SUMMARY OF THE INVENTION

### Objects And Features For the Telecommunication Service Provider

The wireless telephone directory unit provides the means for the telecommunication service provider to give the consumer an unlimited region from, and for which to access directory listings. The CDMA contained within the small end user unit, enables the service provider to make all updates and changes on all telecommunication directory listings quickly and easily. The CDMA, and the operating system within the unit enable the changes to be instantly relayed to the consumer. The SIM card within then stores the data. In doing so, the Wireless Telephone Directory Unit will eliminate all printing, and delivery costs associated with telecommunication service directories. The GPS within the unit will enable the consumer to pick up local directories while in route and for any location in the world. The system also enables the service provider to have more packaging variations, and control over amount charged for directory listings.

### Objects And Features For the Consumer

The wireless telephone directory unit provides a means for the consumer to access telecommunication directory listings for, and from anywhere in the world. The 24 hour instant access is ideal for anyone who is operating a large business, or a residence that does not have Internet access. The CDMA contained within the unit enables the consumer to instantly receive all directory listing changes, and associated service charges. The CDMA and system contained within the unit also enable the consumer to purchase and download frequently used directories based on type or region. The pin system enables multiple end users to create customized directories in a particular end unit, and access, encode, or delete information in those specific directories from anywhere in the world that an addition unit is located. Consumers can also access the SIM located within their home unit from a cellular phone. This frees the consumer from carrying a black book or a palm pilot used for jotting down important address and phone numbers, and which can also be lost or stolen.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity. Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different elements which are similar or related in some way, but have significant modifications. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is

FIG. 2 . . . etc.>

### DETAILED DESCRIPTION OF THE INVENTION

This wireless directory unit is an end user telecommunication device that is intended to operate alone, or to accompany the average telephone operated by a cellular system. This unit is ideal for any place in which it is necessary to quickly locate telephone number and address listings. The unit will automatically locate all residential, business, cellular, government, local, and any other types of listings provided by telecommunication service provider. The system within the unit enables users to locate and store a single listing, or entire directory database of listings, for any geographical areas in the world. The unit was created for multiple end users, and will identify and regulate the customized databases (SIMs) of each individual end user. The port installation and compact design make it possible to conveniently remove, transport, and reinstall the unit. Upgradeable hardware and software expand the system's capacity, making the unit compatible with the needs of residential or business usage.

The interactive unit enables the end user to have continual, unlimited access and control of incoming listing information. The unit contains a security pin system that prohibits the alteration of any information stored within the unit. When an end user subscribes to a particular region or type of directory, the security pin to the designated unit would then be disclosed to the telecommunication service provider. Once the telecommunication service provider gains access, an entire database for the region purchased can be transmitted to the end users' unit. All information is transported through the CDMA and downloaded into the storage device contained within the unit. Around the clock connection to the providers' databases could be established instantly regardless of changes of region caused by travel due to the GPS capability of the unit. The end user has the option to then download, or simply view the listing information.

With this unit, the end user would also have instant, unlimited access to all regional listings, cellular listings, and every other type, at any time by purchasing an entire database, or geo-specific SIMS. This would be ideal for business, which make frequent over-seas calls to various locations. It would also assist in serving those who have family outside of the country. The unit would provide the capability for a user to purchase a directory for a region such as Canada, or China. It is also possible for the service provider to simply charge yearly, all access fees to the end user for the 12-month complete access to all SIMs owned by that provider. The unit also has the capability to calculate the charges accrued for all database transfers, or downloads made from a particular telephone number. The CPU contained within the unit automatically tallies all service charges and toll tax, and transfer fees, and then displayed on the LCD. The decision to enable the unit to operate in this capacity would be left to the discretion of the telecommunication service provider.

This wireless telephone directory unit is a necessary convenience for anyone who travels, or is simply away from home or office. A single metered unit could be placed in airports, gas stations, hotels, restaurants and any other location where someone may need to quickly access a cell, or telephone number or address listing. In this capacity, by entering their alphabetical code name and security pin number, end users could access, encode, and delete phone numbers and addresses contained in their personal SIM. They can also locate directory listings for, and from any location in the world because of the combined technology of CDMA and GPS. Upgradeable hardware and software expand the system's capacity, making the unit compatible with the needs of any size residential or business usage.

The unit can also be created in a port installation and compact design making it possible to conveniently remove, transport, and reinstall the unit. This port-style would be perfect for the home or office where usage is continual and more frequent. The complete, compact unit could generate revenue in any high traffic area. The small wireless units have a magnetized back that will allow a user to pull from the pocket and place on to a refrigerator, or metal cabinet. Best of all, it is intended to fit the price range of the average consumer. Finally, the unit is greatly needed within each and every telephone booth. The unit could be built within the black boxes that embody the cellular phones, and accompanied by a usage meter.

The wireless directory unit is an end user telecommunication device created to operate alone, or to accompany the average telephone operated by a cellular system. The unit can be used as a single unit or built within a cellular telephone. The unit enables an end user to automatically locate all residential, business, cellular, government, local, e-mail and any other type of listing provided by a telecommunication service provider. Within seconds, the paperless system will enable users to locate and store a single listing, or entire directory of listings, for any geographical areas in the world into. CDMA within the unit allows for directory supplier to quickly transfer large amounts of directory data that can then be downloaded into the end user unit. Unit contains a capacity modifiable storage device for alphabetical and numerical data called the SIM Card.

The directory system software program contained within the unit enables the end user to search, locate, create, or delete information contained in available directories. The directories can be custom created by the end user, or downloaded from, and for any region in the world. The GPS within the unit will automatically detect and display regional directories. The multi-functional system operates by displaying a series of simple queries on the LCD. The main menu on the system offers the end users' functional choices such as: “Create a Directory,” “Locate a Listing,” “Add to Personal Directory,” and “Delete Information.” The system will then walk the end user through the task that they have selected by an additional set of queries tailored to that specific selection.

The software system within the unit uses alphabetical, categorical headings to enable the end users to access desired information quickly. The system will automatically locate that particular listing by a series of queries that work downward from geographical size to individual subject. The LCD monitor will display a list of areas to choose from according to the category selected. This method also greatly assists the end user if they are unfamiliar with exact location for which they are searching. The system contains regional headings such as “Country,” “State,” “County,” “City,” and “Local,” in order to assist the end user in targeting a specified location. The categorical headings that are used to locate a specific type of directory are identified by their type such as; “Cellular,” “Business,” “Residential,” Government, and, “Personal.”

For example, if an end user selects “Locate a Listing,” the system will automatically display queries that will assist in locating that particular listing, by requiring the end user to choose a specific region, then a specific type of directory. Again, all information contained within the system is categorized alphabetically. After a country is selected, the user will be provided with a list of states. Once a state is selected user will then be provided with a list of cities to select from. An end user will also be given the option to search by county, in case the name of the city is not known. After the city is selected, the user will be asked to select a letter of the alphabet. Dependant upon the individual letter ultimately selected an alphabetical list of residential or business names and addresses will appear on the LCD screen.

The “function keys” located on the units' interface assist the end user in performing the system operations. They consist of a “12 digit numerical keypad,” “toggle switch,” “enter,” “total,” “+plus,” “clear,” and “reset.” The numerical keypad is used to create security pin numbers, pin identifiers, and all numerical information in personal personalized directories. The “toggle switch” is used to scroll through the list of subject queries and all other information displayed on the units LCD screen. The “enter” key is used to inform the system of the end users' commands by sending and submitting the alphabetical, or numerical values or selections into the units' processor.

In addition, one unit can calculate all outbound toll costs, and services charges made from a particular telephone number, no matter which telephone is used within the location. The “total” key tallies a specified set of numerical values within the CPU and is used to calculate toll calls and service charges. The “+ plus” key when pressed while operating within personal SIM, manually moves curser on LCD to the next available space to enable end user to add unlisted or private numbers into the system for customized SIM. When pressed while operating in directory program, adds the highlighted selection to personal SIM. The “clear” key clears the field of all data input. The “reset” key when pressed once manually clears the field of all input, while resorting the monitor back to default settings such as time. When pressed twice, it will reset directory system program and return back to the main menu.

The numerical, security pin system secures, and prohibits the alteration of all data contained within the unit. This feature makes it impossible for a service provider or any individual to add, or delete the data contained on the SIM without the authorization of the security pin holder. The security pin holder retains access to all contents within the entire system, and at all times. Unique pin identifiers can be assigned to multiple end users in order to create customized databases. The customized databases can contain e-mail, special messages, or any listing published or private telephone listings. The ability for a holder of a pin identifier to add or delete information to is limited to personal SIMs. These customized SIMs can be modified and updated at any time, without permission of the security pin holder. Storage device retains data for all users combined.

With the authorization of the security pin holder, the telecommunication service provider can transmit one particular, or group of telephone directories chosen by the end user. Within minutes, these directories would then be downloaded and stored into the end users unit. Any number of combinations could be tailored to fit the needs of the end user. A businessperson may chose to download a directory for China, but may also have family and associates in Texas. In such case, it would be possible for this individual to download a complete business directory containing listings for China, and an additional directory for containing the listings for Texas. Local directory services would remain available at all times to end users'. It is also possible to have a cellular directory only downloaded into the unit. Any combination is possible as long as the service providers are able to supply the directories.

If the end user wants to download new information to update the entire system, or just a particular region, all fields within the unit that are to be replaced, must first be cleared. It is possible to clear the entire system within a few minutes. The precise amount of time it will take to add or remove a SIM depends of the quantity of information contained therein. The queries displayed on the LCD will walk the end user through the systems' process for database additions and deletions. Message on the LCD coupled with audible alarm will signal deletion or download completion. It is not necessary to add, or download all the directories that are viewed into the system. Around the clock access to all SIMs offered by the telecommunication service provider could be achieved by the touch of a button. The auto-dial feature on the unit would then establish connection. The end user would then simply scroll through the data without downloading, leaving the space available for directories of frequently used numbers only.

It is possible to access, add to, or delete all information contained in a specific end users telephone directory unit, from any location where an additional directory unit is located. A single metered unit directory port could be placed in airports, gestations, hotels, restaurants and any other location where someone may need to quickly access a telephone, address, or e-mail listing. When accessing data from the end users home unit from a foreign port, the system will require a home telephone number and an alphabetical code, in addition to the security pin number. After entering this information, the end user could locate forgotten cell phone numbers and addresses from their personal databases, or directory listings form any location in the world. When used in this capacity, the closed position relay will break circuit transmission after locating a particular number of listings.

This proposed device is specifically created for residential and business usage, and is also greatly needed within each and every telephone booth. The unit could be built within the black boxes that embody the cellular phones, and accompanied by a usage meter. Regardless of its' desired usage, upgradeable hardware and software expand the systems capacity, making the unit compatible with the needs of any size residential or business usage. The usage meter remains an option feature that can be simply installed. The port installation and compact design make it possible to conveniently remove, transport, and reinstall the unit. The complete, compact unit features a user programmable interface, and is intended to fit the price range of the average consumer.

### Function Keys

There are six function keys, in addition to the numerical keypad, that will comprise the wireless telephone directory units' interface. The keys listed below are necessary to operate the telephone directory system, and the software contained within the unit. When built into a cellular telephone, the keypad normally displayed on the single unit can be eliminated and replaced by the use of the telephone keypad.

The function keys consist of:
“Numerical Keypad” Touch-tone 12 digit keypad appears on the units' interface used to create pins, and listings in personal directories. An additional keypad is not necessary when the unit is placed within a cellular telephone.
“Toggle switch” Scrolls written information and queries on LCD screen in an up, down, right, or left direction thereby accessing programming functions.
“Enter” Submits or sends the alphabetical or numerical values or selections into the units' processor.
“Total” Tallies a specified set of numerical values within the CPU.
“+ plus” When pressed while operating within personal SIM, manually moves curser on LCD to the next available space to enable end user to add unlisted or private numbers into the system for customized database. When pressed while operating in directory program, adds the highlighted selection to personal SIM.
“Clear” Clears the field of all data input. Erases individual queries, alphabetical, and numerical values created by the end user.
“Reset” Press once to manually clear the field of all input, while restoring the monitor back to default settings such as time. Press twice to reset directory system program and return back to first subject query.

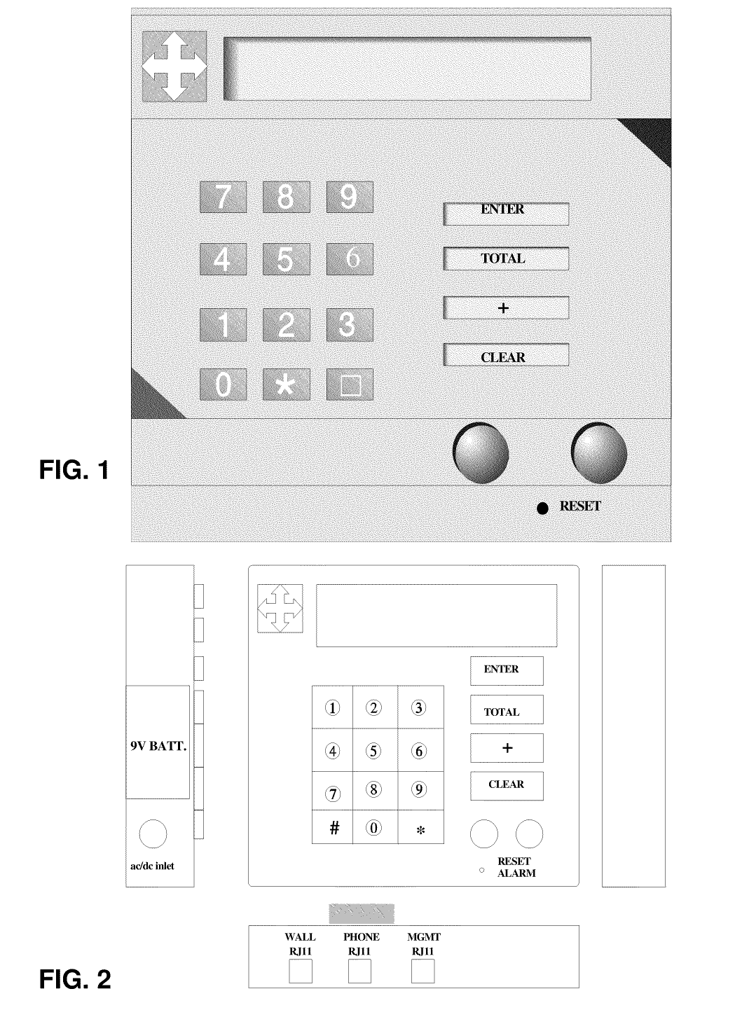

FIG. 1 shows the numerical keypad and six additional function keys that are located on the interface of the wireless telephone directory unit.

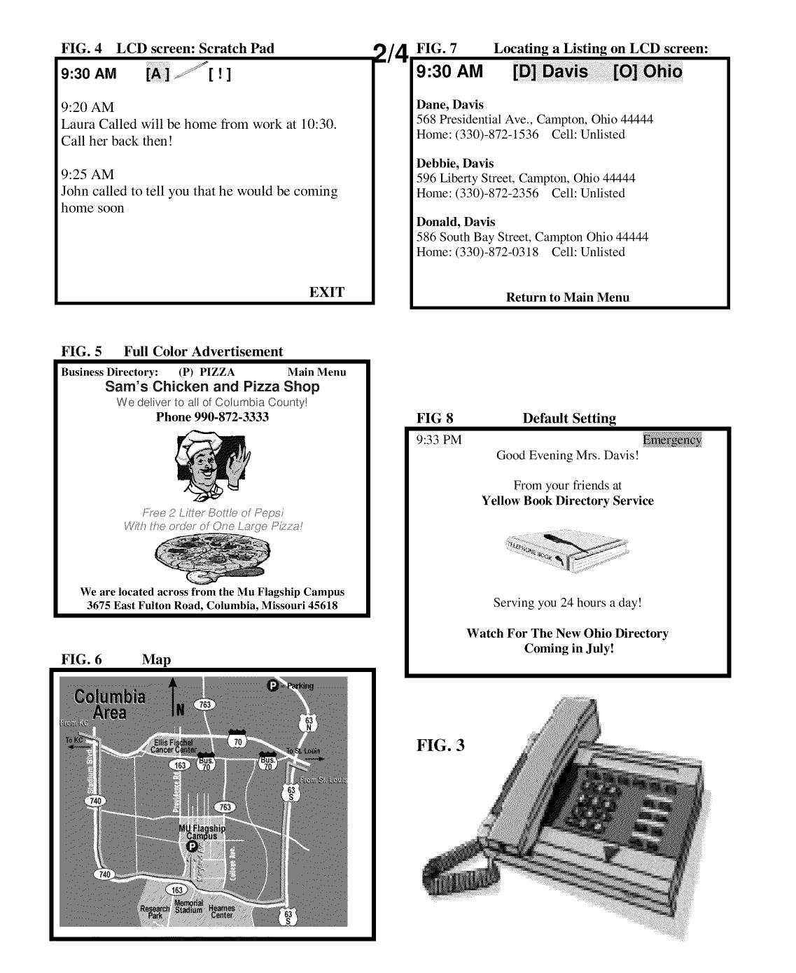

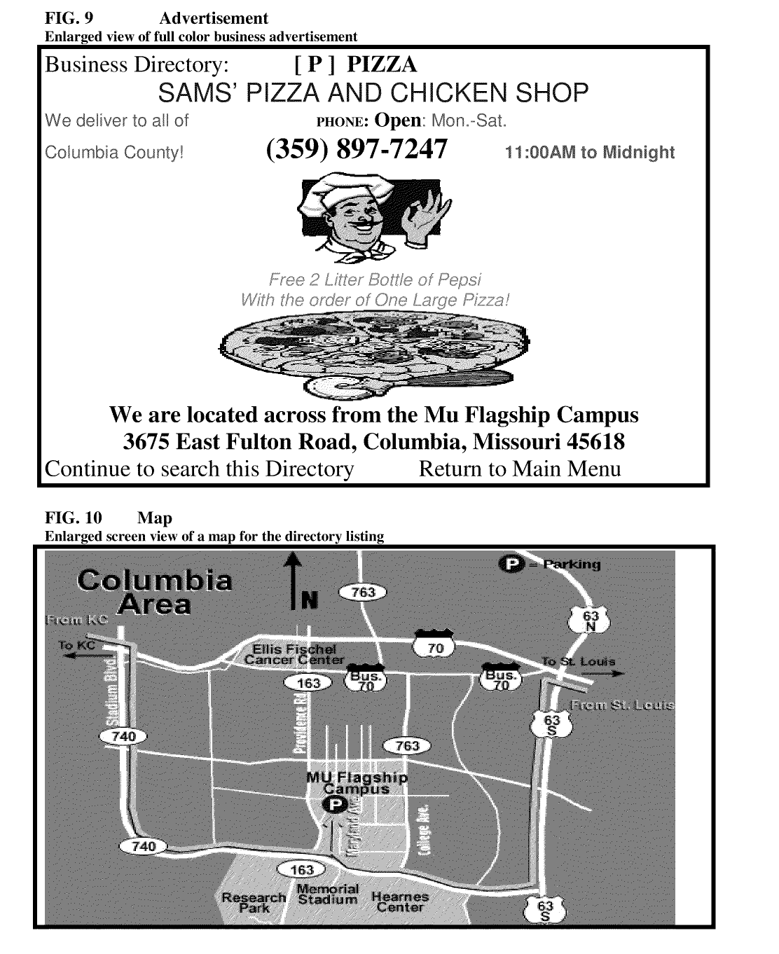

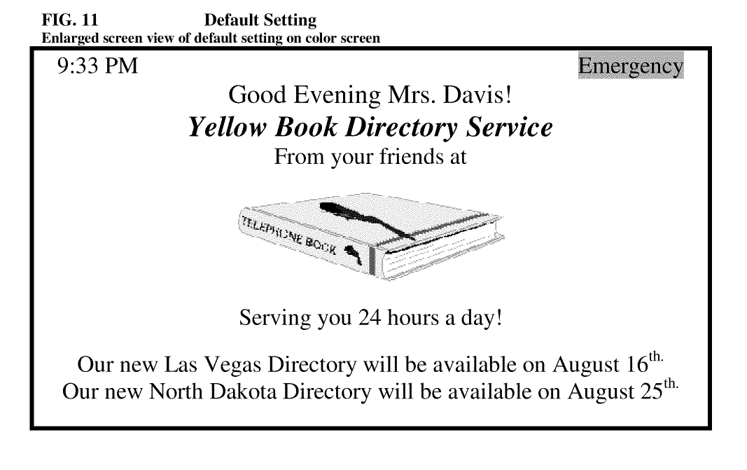

FIG. 2 shows front and side views of the Wireless Telephone Directory Unit. This view shows the location of RJ 11 jacks and the backup battery supply.

Referring again to FIG. 1, it shows the wireless telephone directory unit fully assembled. The interactive unit is designed for the use of cellular telephones and enables the end user to access all telecommunication directories for any particular geographical region. CDMA within the unit allows for directory supplier to quickly transfer large directory databases, and to be stored into the end user SIM Card. Software within the unit compiles, sorts, and retrieves data. A security PIN system prevents the unauthorized alteration of any data. Multiple end users are assigned pin identifiers and create additional customized SIMs. The GPS technology within the unit enables the user to automatically pick up regional directories while traveling.

The software within the wireless telephone directory unit can be used within a separate hand-held component, placed within a cellular unit, or in a land line telephone. Regardless of the hardware used, the keys on the units' interface are necessary to operate the telephone directory system software accessed by the unit. When built into a land line telephone as shown in FIG. 3, the keypad normally displayed on the single unit can be eliminated and replaced by the use of the telephone keypad. A modular conversion-switching device would then need to be added to signal the appropriate system usage.

### Operating System of Wireless Telephone Directory Unit

This telecommunication directory system software is excusive to, and located within the wireless telephone directory unit, that contains the CDMA transfer and SIM storage method. This directory system also contains an alphabetical code and security pin method for the controlled accessing, and sorting of all data stored within the unit.

The telephone directory system will display time, and advertisement on LCD screen when not in use.

### Security System Set Up

After installing the SIM Card into wireless telephone directory unit, the end user will press the “Reset” button twice, and the “enter” key once to initiate the system program. The system will then require the end user to create a unique alphabetical code name and security pin. The system will ask the end user to place the security pin number in twice for verification purposes. The use of the alphabetical code name is only necessary when operating from a foreign port. A pin identifier is not necessary to initiate this process. Pin identifiers will be used only to create personal databases. Once the security pin number is correctly placed twice into the system, the system will welcome the new user.

The system will ask that an alphabetical code name be created before gaining access to the users' home unit. The code name can be up to 15 spaces long. After it is successfully entered, the user would select “END” to submit the name into the system.

The end user will use the numerical keypad located on the units interface to place a five-digit number into the system. Once complete, the “enter” key will then be pressed to enter the information.

The system will require the end user to repeat this process using the same number.

The LCD screen will then display a welcome to the new user.

### Starting the System

To start the directory system, press the “Reset” button. This will cause the first query along with the list of selections known as the main menu to appear on the LCD screen. The main menu on the system offers the end user functional choices that access the systems operations. The options on the main menu consist of: “Emergency,” “Create a Directory,” “Locate a Listing,” “Add to Personal Directory,” and “Delete Information.” The system will then walk the end user through the task that they have selected by an additional set of queries tailored to that specific selection.

### View Charges

The subject heading entitled, “View Charges” will appear on an end users' the home unit.

Upon selecting this category, an itemized list will appear on the end users unit that will display the specified region, quantities, and associated costs of any directory download.

As a convenience to the user, the system will then automatically tally the combined total of all service charges accrued.

The end user can scroll through the main menu list by using the “toggle switch” to move the viewed selections up, down, right or left. A highlighter will darken each individual selection at a time. When the selection that the end user would like to choose appears highlighted, he will then press the “enter” key to submit his or her selection into the system for processing.

### Main Menu

### Emergency Listings

A complete list of Emergency address and telephone numbers will remain visible at all times on the top right corner of the main menu. It is important to note that all emergency numbers will be local based upon the area of the end users unit. If at any time during a system process an emergency number is not located on the LCD screen, but needs to be accessed, press the “Reset” button. The reset button is located on the bottom right corner of the unit and will instantly return the system to its' default settings and display the main menu. The emergency directory is located on the top right corner of the main menu.

### Regional Headings

The system automatically locates particular listings by working downward from geographical size to individual subject. The system regional headings include “Country,” “County,” “City,” “Local,” and “Governmental” in order to assist the end user in targeting specified locations. The system works downward from largest to smallest geographical area. To obtain a Governmental listing, end users will also be required to select a state. In addition, all information contained within the system is categorized alphabetically.

For example, once a country is selected, the user will then be provided with a list of states. For a convenience to the end user, it is possible to set defaults on a home unit to a specific country. Once a state is selected user will then be provided with a list of cities to select from. An end user will also be given the option to search by county, in case the name of the city is not known. After the city is selected, the user will be asked to select a ‘Type’ of Directory.

The LCD screen will display a subject query starting from the largest geographical region and working down to smallest.

The LCD screen will then display an alphabetical list of countries to choose from. Again, when the country that the end user would like to select appears highlighted, he will then press the “enter” key to submit his or her selection into the systems program.

Once the end user selects a country, he will then be asked to choose a state. An alphabetical list of states will then appear on the LCD screen.

Once a state is chosen, the end user will then be asked to select a city.

### Directory Type Headings

Once an area is targeted down to a particular city, the system will then ask the end user to sect a ‘Type of Directory’ for the system to pull from. The categorical headings that are used to locate a specific type of directory are identified by their type such as; “Cellular Directory,” “Business Directory,” “Residential Directory,” and, “Personal Directory.” A ‘Type of Directory’ contains specified listings for the region previously selected. An e-mail directory can also be placed within the unit.

Once a ‘Type of Directory’ is selected, the system will then provide an alphabetical list for the end user to choose from in order to tailor the search to the appropriate location within that particular database. Dependant upon the letter selected an alphabetical list of names and addresses will appear on the LCD screen. If only one letter of the alphabet is entered, the system will automatically take the end user to the beginning of the listings in the directory starting with that particular letter. To tailor the search and end user would want to supply the system with the entire last name of the subject that they are trying to locate. With this method, end user can access the listing information normally contained within the yellow or white pages for an entire region within seconds.

The end user selects a “Directory Type” in order to locate a listing.

Use the “toggle switch” to highlight each individual letter necessary to satisfy the query. When finished, highlight the word “END” and then press the “enter” key to submit

Once a letter of the alphabet has been selected, the system will then present the end user with the available listings

The system will automatically dial the desired telephone listing. Once it has been located, highlight the telephone number by using the “toggle switch.’ Next, lift up the telephone receiver and press the “enter” key on the units' interface. This will automatically connect the end user to that particular telephone number.

It is possible to record, delete, or locate information while on the telephone. At any time during a telephone call, the end user may press the “reset” button to take them back to the original default menu to begin an additional task. This is a necessary feature when an end user needs to locate a listing, or record a number into a personal directory while talking on the phone.

### To Minimize Searches

### All Searches Can Be Minimized At Any Time By Either of Two Methods

First, an alphabetical listing will appear on the LCD screen. User will scroll through and press the “enter” key on highlighted letter of choice. This will pull up the entire database for that category that begins with that letter. Secondly, a user can manually press the first letter of the data to be searched. The letters are located on the numerical keypads of the telephone interface. The letter that is selected will appear in the empty box on the right of the LCD screen. If you make a mistake, simply press the “clear” key. If it is correct, then press the “enter” key to submit selection. The system will pull up all states that begin with the letter chosen that are located in the SIM.

For example: To choose the state of Alaska, use the toggle to scroll down. Once the state appears highlighted on the LCD screen, simply press the “enter” key; or highlight the box in the right hand corner of the screen, then press the letter “A” on the numerical keypad, then pressing “enter”. The system will pull up all states that begin with the letter “A.”

To select Colorado: Highlight the box on the left, then press “C” and press “enter” key.

### To Create A Customized Directory Database

To create a customized, personal database select “Create Directory” on the main menu. Highlight this option by using the “toggle switch.” Once highlighted, press the “enter” key to submit the request into the system.

Next, the system will request a security pin number to be entered by the end user. The security pin holder can create a personalized database, by entering the security pin. Pin identifiers can be assigned to multiple end users to create additional, private databases.

Next, the system will ask the user to select the type of database that is to be created. The selection “Personal Directory” will automatically appear highlighted because the main security pin has not been used. The end user will simply press the “enter” key to gain access to personal database. The system will not permit the end user to scroll through the various options. The system prohibits access to all other directories until a security pin is entered. Multiple directories can be placed within a single SIM Card.

Next, the LCD will display the alphabet and accompanying symbols. The end user will be asked to name the database. The “toggle switch” and “enter” keys will be used to select letters for create the name. To delete a mistake, highlight the individual letter or symbol and press the “clear” key on the units interface. When finished naming the file, highlight the word “END” and press the “enter” key. The submitted information will then be downloaded into the systems storage device. Private listings and e-mail information can also be added by this method.

Use the “toggle switch” to locate desired letter, then press the “enter” key.

Next, the end user can add information to the personalized database. Private listings and e-mail information will be added by using this method. To move the curser down to the next line, press the “+” key. This will automatically reset the curser into the next available field. Then being to scribe information by using the alphabet located at the top. Once all desired information has been added, highlight “END” and then press the “enter” key. This will end the work on the database.

Finally, the system will verify the completion of task.

To create an additional database, return to the main menu and repeat the process.

### To Add Information To Customized Directory Databases

No information can be added to any database without entering a pin number. The security pin must be used to add to all main databases. The only databases that can be altered without the security pin are those databases assigned to users by individual pin identifiers. In such case, the pin identifier must be recognized before any alterations can be made to that particular database. Additional SIM Cards can be purchased providing more space for new directories.

There are two ways to add information to a customized database. First an end user can go directly to the main menu and simply select “Add to Personal Directory.” The system will then request that the end enters a pin identifier, and name of the database be verified. Once access to the desired database is gained, the end user would then manually add the information.

Secondly, it is possible to add a single listing to a customized database from any viewed directory. To add a particular listing to a personalized database, use the “toggle switch” to highlight the desired information. Then, press the “+” key.
Next, the system will request the end user to enter a pin identifier in order to assist the system in locating the personalized database.
Next, the system will ask the end user to select a particular database to place the listing in. Once the listing is highlighted, press the “enter” key to encode the listing.
Finally, the system will notify the end user of successful completion. If the end user presses “Yes”, the system will return to original subject queries. If the user selects “No” the system will then display the time and an advertisement.

### To Delete Information

Data can be removed from a single directory database, or the entire directory system, by responding to queries on the LCD screen. This feature can be used to clear specific fields in order to add updated listings or fee changes. It is not possible to add, or delete a single listing form an outsourced database to create changes. In order to update an outsourced database, the entire database for that categorical heading must first be deleted, and then replaced with a new, updated directory database for that specific type or region. The only database that a single listing can be added to, or deleted from is a customized personal directory.
This removal of information can only be accomplished by first entering a security pin number. The security pin can be used to remove all information from any database within the system, and at any time. The pin identifier is only abele to remove information stored within personal databases. This process only takes a couple of seconds to a few minutes depending on the size of the database that was previously downloaded. For example, if an end user wanted to created an updated directory database for the state of Ohio, or chose to remove the Ohio directory in its' entirety, he would start by going to the main menu. Then simply follow the instructions listed below.
First select “Delete Information” on the main menu by highlighting and pressing the “enter” key.
The system will then request the end user security pin number. Without a valid security pin number, the system will not permit the alteration of any data. A pin identifier is only necessary when altering information in a personal database.
Enter user pin security and then press “enter” key.
The system will then verify your security pin number.
Next, the system will ask the user to select the type of database that is to be deleted. The end user will scroll through the list of selections until “Regional Directory” has been located
Once the “Regional Directory” has been located, highlight and press the “enter” key. The “Regional database” contains all countries, states, cities, counties, local, and government listings. The removal of this database requires a valid security pin number.
Next, select the state location of database that is to be deleted and press the “enter” key.
The listings contained within the “Emergency” category can only be altered by entering the database through the “Delete Information” selection on the menu. The end user may also wish to eliminate, or delete information for “cellular directory,” or “local directory.” These two listings remain as individual selections on the deletion menu. These two databases also require a security pin number for removal. The only databases that don't require a security pin number for removal are the personalized databases. Personalized databases can be removed at any time by entering pin identifier.

Next, the system will assist the end user in specifying the target area to be deleted.

Next, the system will give you an option to tailor your search, or remove the entire database containing all information in the directories within that particular state.
Finally, the system will request database verification. Selecting “yes” and pressing the “enter” key will remove all information contained in that particular database within seconds. The system will notify end user of completion, then return to main menu.
A pin identifier can be used to remove data from personalized databases only. Once the pin identifier is entered and recognized, the system will pull up only those databases created by that particular pin user. A security pin is not necessary when removing this information.
Once you have selected the personalized database that is to be deleted, press the “enter” key to submit the request into the system.
The system will then query the end user once again. Note, when the “enter” key is pressed during this query, that particular database will be removed in its' entirety.
If “No” is selected, the system will then open the chosen database and enable the end user to scroll through all information. Once the specified data is highlighted, it can then be deleted by pushing the “clear” key on the units interface.

### To Add An Entire Database

To add, change or update an entire database such as cellular, local, city, state, or country, the end user must first delete all pre-existing information in the field where the current information will be located. Once the removal is complete, the end user will then work through a series of queries that will assist in downloading the information into the proper category. For example, if the end user wanted to add all listings for the state of Ohio to the unit, after removing all pre-existing information in the state of Ohio database, he would then return to the main and select “Create Directory.” After entering security pin, he would then select to create in a “Regional Directory.”
First, select “Create Directory” by highlighting and pressing the “enter key.”
Next, the system will request a security pin number to be entered by the end user. The security pin holder can create a personalized database, by entering the security pin. Pin identifiers can be assigned to multiple end users to create additional, private SIMs. For this case, to create a regional database within the system, the security pin is required.
Next, the system will ask the end user to select the type of database that is to be created. The end user would then scroll to the list of selections until “Regional Directory” has been located. This is the categorical heading under which all states are located.
Once “Regional Directory” has been located, highlight and press the “enter” key.
The LCD will then display a list or regions to choose from.
Once you have selected a state, the city will give the option to continue the search. To create a directory for the entire state, select the appropriate option and press “enter.”
In order to download a new directory, the existing directory must be removed. The system will notify the end user if there is pre-existing data within a directory. The end user can simply chose to delete this data by selecting the “yes” option.
If there is no pre-existing database the system will ask the end user to begin downloading.
Once the downloading process has been started, the unit will automatically locate and dial into the main databank established by telecommunication service provider. These numbers can be programmed into the default setting within the unit. Once connection has been established, the telecommunication directory unit will begin transporting, and storing the information into the unit. The time it will take the system to complete a download is entirely dependent upon the size of the database.
An audible alarm in conjunction with LCD message will notify the end user of completion.
Once the download has been completed, the end user can then check listings contained within the database, or return to the main menu and begin another task.

### Operating From A Cellular Phone

It is possible to access and view information in all of the directories contained in an end users home unit by using a cellular phone. The only stipulation is that the cellular phone has a readable LCD to display the acquired information. This is particularly useful if an end user is away from the office, but needs to locate a listing from that companies business, or private directory. It is also useful when the need arises while away from home to access a private listing that an end user recorded into a private customized directory. What ever the case may be, the end user would simply dial the home telephone number for which the unit is placed and then enter a pin number to access a directory.
Once the desired number is located, the end user would push a button to trigger the auto dial feature.
While it is possible to access all of the directories and information contained within a particular end unit, it is not practical to delete, or download entire directories using this method. The cellular phone access method is primarily to access and record data info personal databases while away from home. This method is great for placing a private number into one of the end users home directories, so that they do not loose or forget the listing later. This method frees the end user of carrying a palm pilot, or a notebook of any kind to record address and phone numbers.

### Operating From Foreign Terminal

It is possible to access, encode or delete all information contained in a specific end users telephone directory unit, from any location where an additional directory unit is located. A single metered unit directory port could be placed in airports, gestations, hotels, restaurants and any other location where someone may need to quickly access a telephone, address, or e-mail listing. When accessing data from the end users home unit while operating from a foreign port, the system will require will require a home telephone number and an alphabetical code, in addition to the security pin number.
The greeting on the LCD of a telecommunication directory unit located in a foreign port will appear the same. The only differences would be the contents of the advertisement messages that are displayed by the telecommunication service provider. In addition, the LCD will also display the number of listings per usage price in the bottom right corner.
Once the appropriate amount of change is deposited, the system will then ask the user to select the location for the database that the user would like to pull form. If the end user selects “Access Local Directory,” “Access Service Directory,” or “Access Global Directory” the system will then proceed to locate the end users specific listing information by ‘Regional,’ and ‘Type’ Directory queries. This is the same process displayed in queries on home units. Note: The “Emergency” numbers on this screen will be local based upon terminal location. Below is an example of a main menu that may appear on a unit located in a foreign terminal.

The regional directories that are offered my vary based upon location and sponsoring service provider.

An end user will use the “toggle switch” to scroll through the list of countries. Once a country is selected, the system will provide a list of cities for the end user to choose from.
Once the area for the listing is identified, the system will request the end user to select a Type of Directory.
Again, it the complete name is not known, simply entering a single letter will be sufficient to pull a directory.
After scrolling down through headings such as Painters, Parts, and Piano Repairs, the end user will eventually discover ‘Pizza.’
Once autodial is initiated, or the “Reset” button is pressed, the system will automatically deduct a listing from the purchased amount. Before an additional database can be viewed, the “Reset” button must be used to return to the main menu to initiate the task and begin the process for locating an additional listing. Once the end user pushes the “Reset” button, an automated deduction from the number of available listings will occur. The automatic dialing of a selected telephone number can also trigger the automatic deduction feature. The deduction will automatically appear in the top right corner of the LCD screen.
The main menu on every unit in a foreign terminal will enable the end user to access their home unit. After passing security verifications, the end user can proceed to encode or delete private e-mail or telephone listings into the customized directories contained in the users' home unit. All of the options on this menu can be tailored to fit the exact terminal location.
The LCD screen on a foreign terminal unit will always give the end user the option to access the directories within his or her home unit. The remaining main menu selections may vary on a foreign terminal unit dependent upon service provider and location.
If the end user selects “Access Home Unit Directory” the security provisions will begin by asking the end user to enter the home telephone number where the end unit is located.
The system will then verify the end users home telephone number.
Upon verification by the end user, the system will then ask that an alphabetical code name be given by the end user before to gaining access to the users' home unit. The code name can be up to 15 spaces long. After it is successfully entered, the user would select “END” to submit the name into the system.
The system will then request the security number for the end users unit.
Upon successful verification, a short greeting then the main menu will appear. The system will also inform the end user if access is denied in the bottom right corner.
Once access is gained, the following steps on the main menu would be the same as those in the initial at home usage, and dependent upon the task selected.

### Telecommunication Directory Providers Control

Ultimately the telecommunication service provider will control listing access for the end user. Telecommunication directory providers can transfer, block, limit, and monitor access to specified Databases to the end users. End users can purchase access to databases containing frequently used listings by specific geographical areas. The database combinations that an end user may purchase are endless, and tailored to the specific needs of the users for that particular unit. For example; a businessman may want to purchase a directory database for Japan to satisfy his business needs. He may also need to include a directory database for his family and friends that reside in Mexico. It would be possible for this man to purchase two database directories, one for China, and one for Mexico, and create several personal databases on the same SIM Card. Large or industry customized directories can also be sold on separate SIM Cards.
The variety of ways that a service provider packages directory services is also endless While purchasing a directory for an entire country is possible, it may be more practical, and perhaps cheaper, for some users to purchase a directory for particular state or city.
It is also possible to purchase simply by individual listing viewed. This would be ideal for someone who normally does not use directory assistance much at all. Finally, the telecommunication service provider could provide a one-time fee for a year of unlimited viewing access to all databases, or SIMs offered by the provider. Charges will also vary dependent upon whether the information is downloaded or viewed only.
The system contains a code that enables the end users to identify exactly which directories the customer has access to. Purchased areas will display an (*) indicating access to listings in a subscribed area. (NA) will appear to indicate that the end user has not subscribed to this location, and therefore, has restricted access to the listings in this location. Restricted access to a particular database can be lifted at anytime be calling directory assistance.
To Select Connecticut: Press “enter” key. Delaware and Florida cannot be accessed.
The LCD screen below shows the end user that Alaska is an available directory.
When not in use for more than 15 minutes, the system will automatically kick back to default settings.

A detailed description of a preferred embodiment of the operating system will now be presented. This embodiment is described using relatively older electronic devices but it should be apparent to one of ordinary skill in relevant communications arts how to modernize the physical equipment to implement the herein presented inventive method of operation while using more up to date devices that perform functions equivalent to the inventive set of functions. For example, where the described functions are displayed on a small three-line alphanumeric screen in response to keypad button and toggle switch input, an equivalent process of inputting commands and displaying results can be more elegantly accomplished with a larger touch-screen interface. A summary of some of the potential enhancements and alternate embodiments could include:

### Software

1. In the software, a touch screen can be used to make all inputs into the device, rather than a toggle switch.

2. In the software, a SIM card in conjunction with a storage device is used to store data.

(A USB port and cable is provided on hardware so that you computer may act as a massive storage device.).

3. In the software, GPS (Global Positioning System) technology is used to transmit data to be displayed by the unit, instead of a modem.

### Hardware

1. A USB port is located on the on the hardware unit.

2. CDMA (Code Division Multiple Access) Technology is the platform used to transmit voice and data frequencies, in particular the integrated use of 3G technology.

3. A microphone is located on the bottom of the user interface to enable the end user to receive audible information such as pertains to listing information, instructions, and all other information created by recording or cellular output.

4. All buttons on the front of the user interface can be replaced by a touch screen; although the functionality remain the same and is in conjunction with the software commands.

### The PDIal Directory Operating System In General

The PDIal Directory Operating System enables consumers to automatically locate and store all residential, business, government, local, and any other type of listing provided by a Directory Service Provider from a Digital telephone. The PDIal Directory System software is located within The Wireless Directory Unit, and The Digital Telephone Directory System, both of which contain the modem transfer and database storage method. This directory operating system uses an alphabetical code and security PIN method for the control and access of all data stored within a unit.

### Default Settings

The default settings for The PDIal Directory Operating System will automatically display time, and advertisement on LCD screen when not in use. To set the correct time on the system, go to the Main Menu and then select “System Service and Assistance.” This will pull up a catalog of system operations that will walk the end user through all system operations. The end user would them locate and select the heading entitled “Time.” Directional information will then be displayed on the LCD screen that will walk the end through setting this particular feature on the system. As an option, the default settings can also display the ‘Scratch Pad’ when not in use.

### Default Setting

### The Security System

The Security System prohibits the alteration of any data contained within the main system. The Security System consists of one numerical security pin, an alphabetical code name, and numerical pin identifiers. Downloads sent to the “Local,” or the “Telephone Service Guide,” will remain free domains to the Directory Service Provider. The system will not require the entrance of a security pin number, pin identifier, or alphabetical code name to gain access to this portion of the system. This is due to the fact that local area services are generally free and require that updates be frequently made.

The security pin holder of the system will usually be the residential owner, office manager, or service provider custodian. The security pin holder can assign unique pin identifiers to each individual end user. The system access given to pin Identifier holders is limited. Pin identifiers are used to create and access various Personal Directory databases within the system. Pin identifiers cannot alter any of the Information contained within the main system without the authorization of the security pin holder, and entrance of the security pin. The only alterations that are permitted are those made to the personal databases assigned to that particular pin number.
When initially starting and installing a new system, an alphabetical code name will be created. The alphabetical code name, works in conjunction with the numerical security pin, or pin identifiers, to secure the system by prohibiting the addition or deletion of any data contained within the unit. The alphabetical code name will not be required again until accessing data from a foreign system. During which case the home telephone number will first be dialed to locate the home system. The home system will then require that a pin number be entered in combination with the alphabetical code name in order to gain entrance to the systems main directory databases, and personal databases assigned to that particular pin only.
It is important to note that while operating from a foreign terminal, it is not necessary to use a security pin number. The security pin primarily locks the system from accepting unauthorized directory downloads, and as an option, places blocks on specified numbers of global directory views. In addition, end users can add information to databases from any location using the same systematic method of the home telephone number, alphabetical code name, and pin identifier. Once inside, the system will permit end users to view the main downloaded directories, and save a single listing into their personal directory.

### Main Menu

To start the PDIal Directory Operating System, press the “Reset” button. This will cause the first query along with the list of selections known as the main menu to appear on the LCD screen. The Main Menu on the system offers the end-user functional choices that access the systems operations. The options on the main menu consist of: “Emergency,” “Locate a Listing,” “Download Directory,” “Delete Information,” “Create Personal Directory,” “Add to Personal Directory,” “View Charges,” “Scratch Pad,” “Maps,” “System Service and Assistance,” and “Telephone Service Guide.” The system will then walk the end user through the task that they have selected by an additional set of queries tailored to that specific selection.
The end user can scroll through the main menu list by using the “Toggle Switch” to move the viewed selections up, down, right or left. A highlighter will darken each individual selection at a time. When the selection that the end user would like to choose appears highlighted, he will then press the “Enter” key to submit his or her selection into the system for processing. If at any time during the process of one of the system functions an end user needs directional assistance, press the “Reset” button located at the bottom of the unit. This will take the system back to the Main Menu. Then select “System Service and Assistance.” This will pull up a catalog of system operations that will walk the end user through all system operations.

### Main Menu

### Emergency Listings

A complete list of Emergency address and telephone numbers will remain visible at all times on the top right corner of the Main Menu. It is important to note that all emergency numbers will be local based upon the area of the end users unit. If at any time during a system process an emergency number is not located on the LCD screen, but needs to be accessed, press the “Reset” button. The “Reset” button is located on the bottom right corner of the unit and will instantly return the system to the default settings and display the Main Menu. The emergency directory is located on the top right corner of the Main Menu.

### Locating A Listing

When locating a single listing form the directory, the end user will highlight and select “Locate a Listing” on the Main Menu. The system will work downward to search for that particular listing location by queries that will appear on the LCD screen. First the system will ask that the end user make a selection from the ‘Region Menu’. Then, the system will ask the end user to make a selection from the ‘Type Menu’. Finally, the system will ask the end user to select the letter from the alphabet that the search inquiry starts with. The system will then pull the section of the directory for that particular section of the alphabet so that the end user may scroll through. Once the desired listing has been located, the Special System Features “Save Listing,” “Autodial,” “Maps,” and “Zoom” can each be activated on the listing information.

### Download Directory

The PDIal Directory Operating System will enable an end user to download an entire directory databases from the Directory Service Provider. For a directory download to occur in any part of the system other than “Local,” or the “Telephone Service Guide,” the end user must disclose the security pin number of the unit to the Directory Service Provider. Once authorization to the unit has been received, the Directory Service Provider will then transmit the directory of the end users choice to the unit to be downloaded.
Although the storage capacity of the operating unit may be equip to hold several large directories, the system will only allow for one directory to be downloaded at a time. Directory downloads may consist of a various assortment of ‘Regional’ or ‘Type’ Directories. To add, change or update an entire directory database such as city, state, or country, the end user must first delete all pre-existing information in the field where the current information will be located

### Personal Directories

The PDIal Directory Operating System makes it possible to create multiple, customized, Personal Directory databases within one end unit. First, the security pin holder must assign a unique, numerical pin identifier to each individual end user. Once the pin number is established, that particular end user can create as many custom databases as the systems capacity will allow. The Personal Directory databases are used for recording frequently used public, and private telephone numbers, and address listings. All directory information for the Special Feature “Save Listing” goes directly into a Personal Directory of the end users choice. The end user can also record private messages, or create E-mail Directories.
The system will allow the end users to access and alter information in the Personal Directory databases while talking on the telephone. All of the information contained in the Personal Directory databases can be later accessed, added to, or deleted from the end users home unit by selecting the task specific headings located on the Main Menu. In addition, all of the information contained in theses databases can be accessed and altered from any location by the use of an additional Digital Telephone Directory System, Wireless Directory Unit, or a cellular phone equip with an LCD screen. Personal Directory databases can be transmitted to, and downloaded by others such as friends, family or coworkers.

### View Charges

The subject heading entitled, “View Charges” will appear on the Main Menu of a end users' the home unit. Upon selecting this category, an itemized list will appear on the end users unit that will display the specified region, quantities, and associated costs of any directory download. As an option, the system may also display the location of, and monetary totals for viewing a listing from a Global Directory. As a convenience to the end user, the system will then automatically tally the combined total of all service charges accrued. The “View Charges” heading will not appear on the Wireless Directory Unit, which is primarily located in foreign ports. However, this feature can be accessed by the Wireless Directory Unit by first accessing the end users home unit.

### Scratch Pad

The heading entitled “Scratch Pad” is located on the Main Menu. This feature is used for quickly jotting down messages and telephone numbers that can, but may not need to be saved into Personal Directories. When accessed, the top of the LCD screen will display a single letter from the alphabet along side of a pencil. The rest of the screen is blank and used for encoding contact information. These messages can be date and time stamped, and encoded while talking on the telephone. They will remain saved until manually deleted. The Special System Feature “Save Listing” enables the end user to place a message or listing from the Scratch Pad into a Personal Directory. An additional Digital Telephone Directory System, Wireless Directory Unit, or cellular phone can retrieve all messages contained in this feature. It is possible to set the defaults to this page.

### Maps

Another feature of the PDIal Directory Operating System is that is able to pull a map for each directory listing. These area maps will assist the end user in locating such things as the specific listing areas, neighboring cities, new businesses, and in some cases even displaying driving directions. The maps can be accessed by going to the Main Menu and selecting the heading entitled “Maps,” or by selecting the address portion of a single listing. The size and scope of the maps vary from global down to local area. At first, the maps may appear small on the LCD screen. The “Zoom” button when repeatedly pressed, will continually enlarge the viewing area causing its' size to become more visible to the end user. The RJ 11 management jack located on the backside of the system enables the consumer to print these maps for traveling.

### System Service And Assistance

A complete itemized list of the systems' operations can be access by selecting “System Service and Assistance” located on the Main Menu. The list contains information for completing system tasks such as setting the date and time, creating alphabetical codes, creating pin numbers, Download Directory, Creating Personal Directory, and so forth. The small sections contained in the list will also explain to the end user how to change or retrieve a forgotten pin number; and how to set the unit to charge for individual listing locations. If at any time during an operating process the end user needs assistance, press the “Reset” button to access the main menu where the “System Service and Assistance” catalog is located. The queries on the LCD screen will walk the end user through each task. If the end user is continues to experience difficulties, this section will also contain a help desk number for completing operations.

### Telephone Service Guide

The “Telephone Service Guide,” also located on the Main Menu, assists the end user by informing them of local area services. This is the area of the unit that houses the “Local Directory” and remains accessible to the Directory Service Providers without the use of a security pin number. As with the traditional print telephone directories, this section contains a series of sub headings such as “Schedule of Events,” Theaters and Stadiums,” “Area Attractions,” “Transportation,” and “Elder Care.” Directory Service Providers can update this section of the unit as often as necessary without the use of a security pin number. The Special System Features “Save Listing,” “Autodial,” “Maps,” and “Zoom” can each become activated on the listing information contained in all of the ‘Telephone Service Guide’ directories. In addition, there will also be heading links for “Maps,” and “Zip Codes.”

### Type Menu

The PDIal Directory Operating System will require the end user to select from the ‘Type Menu,’ which will enable the system to locate and pull a specified directory. Some of the listing information contained in these headings will be cross-referenced from other directories. The ‘Type Menu heading selections help to better sort the listing information, and target the searches for the end user. ‘Type Menu’ selections will be required each time the end user selects “Locate a Listing,” “Download Directory,” or “Delete Information.” The directory ‘Type Menu’ choices consist of “Personal Directory,” “Residential Directory,” “Business Directory,” “Government Directory,” and “Specialized Directory.” The Special System

Features “Save Listing,” “Autodial,” “Maps,” and “Zoom” can each be activated on the listing information contained in all of the ‘Type Menu’ directories with exception of the Personal Directories.

### Personal Directory

When an end user makes a selection off of the Main Menu such as “Locate a Listing,” “Download Directory,” or “Delete Information,” a list of ‘Type Headings’ will then appear on the LCD screen. The ‘Type Heading Menu’ subject entitled “Personal Directory” will enable the end user to access all information contained in a Personal Directory databases assigned to a particular numerical security pin, or pin identifier. Multiple directory databases can be created and stored for one pin number. The correct number must first be entered into the system before downloading an additional database, or gaining access to the list of names of the current Personal Directories created for that number. Once the desired directory database has been located and accessed, the end user can make any necessary additions or changes. The Special System Features “Save Listing,” “Autodial,” and “Zoom” can each be activated in properly structured Personal Directories.

### Residential Directory

The “Residential Directory” contents are equivalent to that of the White Pages contained in a traditional printed telephone book. This heading is used to access names, addresses, telephone numbers, and possibly cellular phone numbers for all published residents. A residential listing can be located for any region in the world. The system will require that the end user select a specified location for the listing from the ‘Region Menu’ in order to tailor the search. The Special System Features “Save Listing,” “Autodial,” “Maps” and “Zoom” can each be activated for all of the information contained within a Residential Directory.

### Business Directory

The “Business Directory” contents are equivalent to that of the Yellow Pages contained in a traditional printed telephone book. This heading is used to access names, addresses, and telephone numbers for businesses, companies, industries, doctors, lawyers, and the like. The ‘Region Menu’ will enable the end user to scroll through listings of business for any country in the world. Directory Service Providers to scan personal photos, life images, and animated cartoons into main databases to create full color business advertisements. These advertisements can be retrieved and viewed by the PDIal Directory Operating System, in conjunction with the Digital Telephone Directory System. The Special System Features “Save Listing,” “Autodial,” “Maps” and “Zoom” can each be activated for all of the information contained within a Business Directory.

### Government Directory

The “Government Directory” contents are equivalent to that of the Yellow Pages contained in a traditional printed telephone book. This heading is used to access the names, addresses, and telephone numbers for all government offices in the world. This heading will access all listing information available specifically for Local, State, and Federal Governmental Offices by the additional use of the ‘Region Menu.’ The PDIal Directory Operating System enables all offices such as the C.I.A., F.B.I., the Office of Foreign Affairs, and all foreign and local Embassies to be located and accessed at the touch of a button. The Special System Features “Save Listing,” “Autodial,” “Maps” and “Zoom” can each be activated for all of the information contained within a Government Directory.

### Specialized Directory

The heading “Specialized Directory” contains directory packages from listings that would normally be contained in the Yellow Pages of the traditional printed telephone book. Many of the listings contained under “Specialized Directories” are cross-referenced from other throughout other sections of the system. Mainly, a gathering of a particular type of data for an establishment is accessed through this heading. Specialized Directories can contain directories with exclusive information for Hospitals, Hospital Equipment, Hospital Staff, Specialized Industries, College Campus Personnel, Campus Class Schedules', Particular Industry Tools, Airports, Musicians, and any other type of directory requested by the public, and offered by the Directory Service Provider. The Special System Features “Save Listing,” “Autodial,” “Maps” and “Zoom” can each be activated for all of the information contained within a Specialized Directory.

### Region Menu

The PDIal Directory Operating System works downward from Geographical size to target the precise area of a listing. The ‘Region Menu’ contains area headings that will enable the end user to target the specified location of a search for a directory selected from the ‘Type Menu.’ The end user will be presented with the option to view the entire region selected or break it down. This is a great convenience to the end user who may not know the particular listing area. When country is selected the screen will display a list of countries. They consist of

“Global,” “Country,” “State,” “Metropolitan City,” “Local,” and “Zip Code.” When “Metropolitan City” is selected, a list of the major metropolitan cities in the United States will appear on the screen such as New York, and Chicago. This section of the data will be different for systems in different countries.

When a particular state is selected from the ‘Region Menu,’ a subheadings list will be displayed for that state such as, “Entire State,” “City,” “County,” “Township,” “Village” “Local,” and “Zip Code” for the end user to select from. When “zip Code” is selected, the system will permit the end user to manually enter a zip code, and then pull a directory containing listings for that particular area. As a convenience to the end user, the system will also display a numerical list of zip codes along with the names of the areas for that particular local area only. Highlighting and selecting a zip code from this list will pull the directory for that particular area as well.

### Special System Features

### Special System Features

The Special System Features contained within the PDIal Directory Operating System assist the end user with the primary functional features of the operating system. They consist of “Save Listing From Directory,” “Save Listing From Caller ID,” “View Charges,” “Scratch Pad,” “Autodial,” “Maps,” and “Zoom.” The Special Features “View Charges,” “Scratch Pad,” and “Maps” have been discussed in the Main Menu section.

### Save Listing From Directory

The Special Feature “Save Listing From Directory” provides a simple way for the PDIal Directory Operating System to assist the end user in creating customized Personal Directories. Once the end user locates a particular listing from a directory, it can be highlighted, and then saved to a Personal Directory. This enables the end user to create their own specialized, Personal Directories to help organize activities or events that may be going on in their lives. Directories can be created for such things as family, work contacts, college friends, membership, clubs, health care facilities, or hobbies. The ‘Save Listing’ feature works in created or downloaded Personal Directories, as well as those downloaded or viewed from the Directory Service Provider. The feature also works while talking on the telephone, and for saving messages and listings from Scratch Pad.

### Save Listing From Caller ID

For telephones that have caller ID build into the system, the PDIal Directory Operating System will save a listing located on the LCD screen generated by caller ID, into a Personal Directory. This simple task is accomplished the same way that an end user would save a listing from a directory. Simply scroll down until the desired listing is highlighted, then press “+” key. Then, use the pin identifier to tell the system what directory to place the listing in.

### Autodial

The Special Feature entitled “Autodial,” will instantly connect an end user to a telephone number located in any directory listing. The feature helps to achieve speed and maintain accuracy in dialing. Once the desired listing has been located and highlighted, the system will automatically dial the desired telephone listing without manually pressing each individual number. Using the “Toggle Switch” for locating, and highlighting the telephone number portion of the listing only activates the feature. Then, by lifting up the telephone receiver and pressing the “Enter” key on the units' interface the system will automatically connect the call to the highlighted and chosen telephone number. It is important to note that this feature will work in Personal Directories if set up properly.

### Zoom

Pressing the “Zoom” button located on the bottom right side of the numerical keypad can enlarge directory listing information and Maps. The “Zoom” button acts as a fast enlargement feature and enables the consumers to select the size that most suits their visual acuity. To make a listing bigger, the end user would simply press the “Zoom” button repeatedly until the desired size is achieved. After pressing so many times, the system will default back to its original size and enable the end user to start the process again. A combination of the “Toggle Switch” and the “Zoom” button, assist the end user greatly in identifying important details on a map.

### Method of Operation

### Starting the System

After installing the PDIal Wireless Directory Unit, or the PDIal Digital Telephone Directory System, the end user will be greeted by the directory providers' name and company logo. The end user will then press the “Reset” button twice and the “Enter” key once to initiate the Security System program. To assist the end user, all programming and operating functions will be explained by writing that will often appear in the form of queries on the LCD screen. To make selections, the end user will use the “Toggle Switch” located on the units interface.

The “Toggle Switch” will move the highlighter to the right, left, up, or down. Once the selected area is highlighted, the end user will then press the “Enter” key to submit the selection to the operating system.

The system will require the end user to create a unique alphabetical code name and security pin. This will be accomplished by the numerical keypad located on the units interface. The system will ask the end user to place the security pin number in twice for verification purposes. Again, the use of the alphabetical code name is only necessary when operating from a foreign port terminal. A pin identifier is not necessary to initiate this process. Pin identifiers will be used only to create and access Personal Directory databases. Once the security pin number is correctly placed twice into the system, the system will welcome the new end user.
When the system asks the end user to create an alphabetical code name, the right and left function “Toggle Switch” will be used to scroll the highlighter to the specific section at the top of the screen that contains the individual upper or lower case letters, or symbols. The up and down function on the “Toggle Switch” will then be used to scroll through the alphabet and symbols. The alphabetical code name can be up to 15 spaces long. After the code name is successfully entered, the end user would select “END” to submit the name into the system.

### EXAMPLE

“Toggle Switch” right or left: [symbol] [h] [@]
“ToggleSwitch”up or down: a b c d e f g h I j k l m n o p q r s t u v w x y z
A B C D E F G H I J K L M N O [symbol] Q R S T U V W X Y Z . , !@#$ % ̂& * ( ) _ +

### Alphabetical Code Name Creation

Next, the system will require the end user to create a numerical security pin number. The end user will use the numerical keypad located on the units interface to place a five-digit number into the system. Once complete, the “Enter” key will then be pressed to enter the information into the systems' processor. For verification purposes, the system will require the end user to repeat this process using the same number. Once the verification process is complete, the LCD screen will then display a welcome to the new end user.

### Entering Security Pin Number

### Verifying the Security Pin Number

### System Access Gained

### Locate A Listing

After the greeting appears on the Main Menu, the end user will them highlight the words Main Menu at the bottom of the default setting. Once the Main Menu has been highlighted, the end user would then press the “Enter” key to submit the request into the systems processor. When the end user selects “Locate a Listing,” “Download Directory,” or “Delete Information,” the system the system will automatically display the Type Menu.
The categorical headings that are used to locate a specific type of directory are identified by their type such as; “Personal Directory,” “Residential Directory,” “Business Directory,” and, “Specialized Directory.” A ‘Type of Directory,’ refers to the nature of a particular type of listing groups. It is important to note that selecting “Specified Directory” will access a menu with headings for directories that contain specified groupings of listing information for a particular type of establishment.
Once a selection is made from the ‘Type Menu,’ the system will then display the ‘Region Menu’ and request that the end user selects an area for the search. If the end user does not know the exact area for the listing, the system will offer selections in the form of subheadings for the end user to choose from. Once an area has been selected from the ‘Region Menu,” the system will then provide an alphabetical list in a box on the top of the LCD screen for the end user to choose from in order to tailor the search to the exact listing location within that particular database. To tailor a search down to an individual listing, the end user would want to supply the system with the entire name of the subject, or establishment that they are trying to locate. The end user will use the “Toggle Switch” to scroll left and right through the alphabet. When the desired letter appears in the highlighted box, the end user will then press the “Enter” key. The selected letter will then appear on the screen. When they are finished, they will highlight the word “FIND” and press the “Enter” key.
To search an entire directory, only one letter of the alphabet would be entered. If only one letter of the alphabet is entered, the system will automatically take the end user to the beginning of the listings in the directory starting with that particular letter. To tailor the search even more, the end user can enter two letters and then press “FIND.” Dependant upon the letter or letters selected; an alphabetical list of names and addresses will appear on the LCD screen containing the requested information pulled from the selected database. With this method, the end user can access the listing information normally contained within the yellow or white pages for an entire region within seconds.
Example: If an end user wanted to locate a listing for a resident of Ohio named Donald Davis, he would:
Use the “Toggle Switch” to highlight Main Menu and then press the “Enter” key.
Use the “Toggle Switch” to highlight “Locate a Listing” on the Main Menu, and then press the “Enter” key.
Use the “Toggle Switch” to highlight “Residential Directory” on the ‘Type Menu’ and then press the “Enter” key.
Use the “Toggle Switch” to highlight “State” from the Region Menu, and press the “Enter” key.
Use the “Toggle Switch” to highlight “Ohio,” and then press the “Enter” key.
The end user would select the entire Ohio Directory then, and then press the “Enter” key.
Use the “Toggle Switch” to highlight each individual letter needed to spell the name. Press the “Enter” key after selecting each individual letter to cause that particular letter to appear on the screen.
When finished, highlight the word “FIND” and then press the “Enter” key to submit

### Listing Database Located

Use the “Toggle Switch” up and down to scroll through the listings in the directory.

### Locate An Additional Listing

### Locate An Additional Listing Within the Same Directory

Once inside a database the end user decides to late a different listing, the end user must be mindful of the ‘Type’ and ‘Region’ that he wishes to seek in. It is simple to locate an additional listing within the same directory ‘Type’ and ‘Region’ that the end user is currently in. The end user would simply highlight the letterbox at the top of the screen. Then scroll left or right until finding the first letter of the, in this case, last name of the subject desired. Then press the “Enter” key. The system will then automatically present the end user with the beginning of available listings for that particular letter. This method can be repeated as often as necessary.
Example: If while in the current directory an end user wanted to locate a listing for a resident of Ohio named Laura Vasic, he would:
Highlight the letterbox then toggle right until finding the letter “V” then press the “Enter” key.
After the “Enter” key was pressed the system located the listing database

### Locating A Listing From A Different Directory

While in a directory the end user wishes to locate a different listing for a different ‘Type,’ of directory, or ‘Region’ the end user will highlight that particular area of the screen that he wishes to change and press “Enter.” The system will then display a list for that particular menu to choose from. Again, the selections from the list are highlighted and submitted by pressing the “Enter” key. Once the “Enter” key is pressed in a menu, the will pull and display directory beginning with the letter that is in the letterbox.
Another way of locating a listing within a different ‘Type,’ or ‘Region’ directory, is that the end user can press the “Reset” button and start from the Main Menu. Beginning the process from the Main Menu will reset the type, and area search transmittals within the operating system to ensure access to the correct database. Pressing the “Reset” button is not necessary when the ‘Type,’ or ‘Region’ is different than the directory that the end user is currently in, but it can be used. When the “Reset” button is selected, the steps taken would then be the same as shown above only with the new information substituted.
Example: If while in the current directory the end user wanted to locate a listing for a dentist office in Texas, the end user would:
Highlight the ‘Type Menu’ heading “Residential Directory” and press “Enter”
After pressing “Enter,” the system will display a ‘Type Menu” on the screen.
The end user would then select “Business Directory” and press “Enter.”
The system will bull the Business Directory for Ohio. The end user will then change the ‘Region Menu’ by highlighting and selecting Ohio.

### Changing the Regional Heading

### To Create Personal Directory

### Personal Directory

It is possible to create multiple, customized, personal databases within one end unit. First, the security pin holder must assign a unique, numerical pin identifier to each individual end user. Once the pin number is established, that particular end user can create as many databases as they would like, only dependent upon the system capacity of that particular unit. These customized, Personal Databases are great for recording frequently used public and private listing information, and for categorizing particular groups of listings. They are a great convenience to anyone who needs to jot down a telephone number or address while talking on the phone, without the hassle of locating a pad and pen.
To create a customized, personal database select “Create Personal Directory” on the Main Menu. The system will request a security pin number to be entered by the end user. The security pin holder can create a Personal Directory database, by entering the security pin. Pin identifiers can be assigned to multiple end users to create additional, private databases. Next, the system will ask the end user to select the type of database that is to be created to assist the end user in formatting the data. The selection “Personal Directory” will automatically appear highlighted because the main security pin has not been used. The end user will simply press the “Enter” key to gain access to an empty database for Personal Directory. For security purposes, the system will not permit the end user to scroll through the various options and directories without a valid security pin, or pin identifier.
Once empty data space is gained, the LCD will display the alphabet and accompanying symbols. The system will ask the end user to name the database. The “Toggle Switch” and “Enter” key will be used to select letters for creating the name. To delete a mistake, highlight the individual letter or symbol and press the “clear” key on the units interface. When finished naming the file, highlight the word “END” and press the “Enter” key. The submitted information will then be downloaded into the systems storage device.
Highlight “Create Personal Directory on Main Menu, and then press the “Enter.”
Enter the security pin number if previously assigned. If not, must also enter pin identifier.
Enter the type of database that is to be created. This will enable system to structure format.
Use the “toggle switch” to locate desired letter, then press the “Enter” key after each.
Once all desired information has been added, highlight “END” and then press the “Enter” key. This will end the work on the database.
System will verify the completion of task.
To create an additional database, return to the main menu and repeat the process.

### Add To Personal Directory

### Add To Personal Directory

Finally, when operating within “Add to Personal Directory,” the encoding and deletion operations are manual. The letter, symbol, and number boxes will be displayed at the top of the screen. The “+” key operates as a cursor and moves only to the right field, or down to the next available line. The “Clear” key moves the curser to the left and deletes single bits of information. This enables the end user to update, add, or change specific bites of information to optimization customization and accuracy in the Personal Directories. Selecting “END” while operating within the “Add to Personal Directory” will save the information and take the end user back to the Main Menu. Each of these directories can be downloaded and shared with family and friends.
Use “Toggle Switch” and “Enter” key to encode messages

### Special System Features

### Save Listing

As previously mentioned, the Special Feature “Save Listing From Directory” provides a simple way for the PDIal Directory Operating System to assist the end user in creating customized Personal Directories. Once the end user locates a particular listing from any directory, it can be highlighted, and then saved to a Personal Directory. This task is accomplished by highlighting the entire listing and then pressing the “+” button located on the units interface. The system will ask that a pin identifier be entered to enable the system to store the listing in its' precise directory location. Queries will also appearing so that the end user selects the correct name of the directory chosen. The ‘Save Listing’ feature works in created or downloaded Personal Directories, as well as all those downloaded or viewed from the

Directory Service Provider. The feature also works for saving messages and listings from Scratch Pad. This feature will only allow for one listing to be saved at a time.

Example: To save a listing for Donald Davis into a Personal Directory, the end user would:
Highlight entire listing and press the “+” key.
Enter the pin identifier for the Personal Directory Database, when finished press “Enter.”
Select the appropriate name of the directory database for the listing.
Verify where that the information is being placed in the proper directory database.

### Listing Save Completed

### Deleting Added Listings From Personal Directory

### Deleting Added Listings

After adding listing and saving it into a Personal Directory, the end user changes his mind and wishes to delete the listing information the system will assist the end user in this process. The end user must highlight and select “Delete Added Listing.” The most recently added listing from that particular directory will then appear on the screen one at a time, along with the “Yes” or “No” selections for verification purposes. Once the end user highlights and selects

“Yes” by pressing “Enter,” the listing will be deleted. The system will allow the end user to repeat this process as often as needed.

Another way to delete a single listing from a Personal Directory is to enter the specific directory by selecting “Delete Information” on the Main Menu. Then, select “Personal Directory” on the ‘Type Menu.’ Once the pin identifier has been entered, locate the appropriate directory. Once the listing in that particular directory has been located and highlighted, press the “Clear” key. The “Clear” key will instantly delete all information in the entire field that is highlighted. This method will enable the end user to delete a specified field for name, address, or number changes.

### Autodial

The system will automatically dial the desired telephone listing. Once the desired listing has been located, highlight the only the telephone number portion of the listing by using the “Toggle Switch.' Next, lift up the telephone receiver and press the “Enter” key on the units' interface. This will automatically connect the end user to that particular telephone number.

### Autodialing the Residence of Donald Davis

### Maps

The system Main Menu provides a direct route for accessing a map. However, after locating the desired listing for any directory listing, other than those contained in Personal Directories, it is possible to pull up a location map for that specific area. To do this the end user must simply use the ‘Toggle Switch’ to highlight the name and address portion of the listing on the LCD, and then press “Enter.” The system will automatically display a map for that listing location. Initially, the map on some LCD screens may appear very small. The end user must use the ‘Toggle Switch’ to move the map up, down, left, or right. The “Zoom” button as repeatedly pressed makes the maps appear larger. The combination of the ‘Toggle Switch’ and the repeated pressing of the “Zoom” button will quickly enable the end user to clearly view the precise desired location.
Pulling a Map for Newton Falls, Ohio. Highlight address and press “Enter”
Map has been pulled. Press the “Zoom” button to enlarge.

### Important Note

It is possible to record, delete, access information, and even operate the Special Features, such as pulling up a directional map, for any listing while the telephone is in use. At any time during a telephone call, the end user may press the “Reset” button to take them back to the original default menu to begin an additional task. This is a necessary feature when an end needs to locate a listing, or record a number into a Personal Directory while talking on the phone.

### Regional Headings

### Regional Headings

As previously mentioned, the system automatically locates particular listings by working downward from geographical size to individual subject. The system regional headings located on the ‘Region Menu’ include “Global,” “Country,” “State,” “Metropolitan City,” and “Local,” in order to assist the end user in targeting specified locations. The system works downward from largest, to smallest geographical area. Therefore, dependent upon which region the end user selects, they will encounter a listing of subheadings to help narrow the search down to the precise directory. Another reason for the subheadings is to inquire if the end user wants to view the entire directory for the selection or just a specified portion. This is not true for a Global region directory. The Global region does not have a subheading and will contain a long, long list containing a mixture of listings for every country in the world. In addition, all information contained within the system is categorized alphabetically.
For example, if “Country” is selected, the end user will then be given the option to select to view the listings for the entire country, or provided with a list of countries to select from. If the end user wishes to view the entire country, when the country is highlighted, he would press “Enter” twice. This will pull of a database containing listings for that entire country. If “State” is selected, the system will give the option to view all listings for that state, or provide a list of states for the end user to select from. If the end user does not press “Enter” twice, the system will continue to work downward. For a convenience to the end user, it is possible to set defaults on a home unit to a specific country. Once a specific state is selected, the end user will then be provided with a list of cities to select from. An end user will also be given the option to search by county, in case the name of the city is not known. On some systems, after the city is selected, the end user will be asked to select a ‘Type’ of Directory. The LCD screen will then display an alphabetical list of countries to choose from.
Again, when the country that the end user would like to select appears highlighted, he will then press the “Enter” key to submit his or her selection into the systems program. Once the end user selects a country, he will then be asked to choose a state. An alphabetical list of states will then appear on the LCD screen. In purchased based directories, letters (NA) and the symbols (*) will appear will appear on the right of the LCD screen. A letterbox will also appear on the top right. The letterbox enables the end user to tailor the search to subjects that begin with the letter selected for the box. If you make a mistake, simply enter the desired letter over again, and press “Enter.” If it is correct, then press the “Enter” key to submit selection. The system will pull up all states that begin with the letter chosen that are located in the database.
For example: To choose the state of Alaska, use the toggle to scroll down. Once the state appears highlighted on the LCD screen, simply press the “Enter” key; or highlight the box in the right hand corner of the screen, then use the “Toggle Switch” to scroll left until the letter “A” has been located, then pressing “Enter”. The system will pull up all states that begin with the letter “A.”

### Selecting From the ‘Region Menu’

The system will display a list of countries as a subheading.
After selecting a country the system will give the option to select a state.
Once a state is chosen, the end user will then be asked to select a city.
The end user can enter the first letter of the subject that they are seeking in the letterbox.
To view the entire directory for Colorado highlight and press “Enter” twice. Highlight and “Enter” once to view a list of cities for Colorado.

### To Delete Directory

### Delete Directory

Data can be removed from a single directory database, or the entire directory system, by responding to queries on the LCD screen. This feature can be used to clear specific fields in order to add updated listings or fee changes. It is not possible to add, or delete a single listing form an outsourced database to create changes. In order to update an outsourced database the entire base for that categorical heading must first be deleted, and then replaced with a new, updated directory database for that specific type or region. The only database that a single listing can be added to, or deleted from is a customized, Personal Directory database.
This removal of information can only be accomplished by first entering a security pin number. The security pin can be used to remove all information from any database within the system, and at any time. Personal Directory databases can be removed at any time by entering the pin identifier assigned to that particular database. The only other databases that do not require a security pin number for removal are the Emergency, Local, and those directories contained in

Telephone Service Guide. Entering the database through the “Delete Information” selection on the Main Menu is the only way for the end user to alter the directory listings contained within the “Emergency” category.

In addition, the deletion process only takes a couple of seconds to a few minutes depending on the size of the database that was previously downloaded. For example, if a end user wanted to created an updated directory database for the state of Ohio, or chose to remove the Ohio directory in its' entirety, he would start by going to the Main Menu. Then simply follow the instructions listed below.
First select “Delete Information” on the Main Menu by highlighting and pressing the “Enter” key.
Then enter the security pin number.
The system will then verify your security pin number.
Then select from the ‘'Type Menu’ the type of directory that is to be deleted.
Then select the location of the directory.
Next, the system will assist the end user in specifying the target area to be deleted.
Select specific area of information to delete from Ohio Directory.
The system will then identify the directory that the end user is about to delete for verification.
The system will erase all data contained in the selected database upon highlighting “Start Deletion” and pressing the “Enter” key.

### To Delete Personal Directory

A pin identifier must be used to remove an entire Personal Directory databases. Once the pin identifier is entered and recognized, the system will pull up only those databases created by that particular pin user. After the name of the specific directory is selected, the system will delete the entire database. A security pin is not necessary when removing this information. Only one Personal Directory database can be removed at a time.
Enter the pin identifier.
Select the Personal Directory database that is to be deleted, then press “Enter”
Once the “Enter” key is pressed during this query, that particular database will be removed in its' entirety.
If “No” is selected, the system will then open the requested database and enable the end user to scroll through all information. Once the specified data is highlighted, it can then be deleted by pushing the “Clear” key on the units interface.

### Download Directory

### Download Directory

A directory download will not be accepted into the unit, until the unit identifies the correct security pin. To download an entire directory database such as a North Dakota Directory, Specialized Directory, or a Metro City, the end user must first delete all pre-existing information in the field where the current information will be located. Once the removal is complete, the end user will then work through a series of queries that will assist in downloading the information into the proper category. For example, if the end user wanted to add a Business Directory for the entire state of Ohio into the unit, after removing all pre-existing information in the state of Ohio database, he would then return to the Main Menu select “Download Directory.”
After entering and verifying the security pin number, the system will ask the end user to make a selection from the ‘Type Menu’ to establish the type of database that is to be created. He would then select to create in a “Region Menu.” Once the region for the new directory has been selected, the system will request a security pin number to be entered by the end user. The security pin holder can create a personalized database, by entering the security pin. For this case, to create a regional database within the system, the security pin is required, as is with all directory downloads. The end user would then scroll to the list of selections until “Ohio Directory” has been located. The state of Ohio is located under the categorical heading “State” under which all states are located and listed. Once you have selected a state, the system will give the option to continue the search. To create a directory for the entire state, select the appropriate option and press “Enter.”
In order to download a new directory, the existing directory must be removed. The system will notify the end user if there is pre-existing data within a directory. The end user can simply chose to delete this data by selecting the “Yes” option. Once the downloading process has been started, the unit will automatically locate and dial into the main databank established by Directory Service Provider. The telephone numbers for the main location can be programmed into the default setting within the unit. Once connection has been established, the directory unit will begin transporting, and storing the information into the unit. The time it will take the system to complete a download is entirely dependent upon the size of the database.
First, select “Download Directory” by highlighting and pressing the “Enter.”
Enter and verify the security pin number.
Make a selection from the ‘Type Menu’ by highlighting and selecting “Business Directory”
Make a selection form the ‘Region Menu’ by highlighting “State” and then press the “Enter” key.
Select specific area of information to download from Ohio.
End user must delete any existing information
If there is no pre-existing database the system will ask the end user to begin downloading.
An audible alarm in conjunction with LCD message will notify the end user of completion.
Once the download has been completed, the end user can then check listings contained within the database, or return to the Main Menu and begin another task.

### Operating From A Cellular Phone

### Operating From A Cellular Phone

It is possible to access and view information in all of the directories contained in an end users home unit by using a cellular phone. The only stipulation is that the cellular phone has a readable LCD to display the acquired information. This is particularly useful if an end user is away from the office, but needs to locate a listing from that companies business, or private directory. It is also useful when the need arises while away from home to access a private listing that an end user recorded into a private customized directory. Whatever the case may be, the end user would simply dial the home telephone number for which the unit is placed and then enter a pin number to access a directory.
Once the desired number is located, the end user would push a button to trigger the auto dial feature.
While it is possible to access all of the directories and information contained within a particular end unit, it is not practical to delete, or download entire directories using this method. The cellular phone access method is primarily to access and record data info personal databases while away from home. This method is great for placing a private number into one of the end users home directories, so that they do not loose or forget the listing later. This method frees the end user of carrying a palm pilot, or a notebook of any kind to record address and phone numbers.

### Operating From Foreign Terminal

It is possible to access, encode or delete all information contained in a specific end users telephone directory unit, from any location where an additional directory unit is located. A single metered unit directory port could be placed in airports, gestations, hotels, restaurants and any other location where someone may need to quickly access a telephone, address, or e-mail listing. When accessing data from the end users home unit while operating from a foreign port, the system will require will require a home telephone number and an alphabetical code, in addition to the security pin number, or pin identifier.
The greeting on the LCD of an Wireless Directory Unit located in a foreign port will appear the same. The only differences would be the contents of the advertisement messages that are displayed by the telecommunication service provider. In addition, the LCD will also display the number of listings per usage price in the bottom right corner.

### Default Setting On An Wireless Directory Unit Located In A Foreign Port Terminal

### Locating Listing From A Foreign Terminal

Once the appropriate amount of change is deposited, the system will then ask the end user to select the location for the database that the end user would like to pull form. If the end user selects “Access Local Directory,” “Access Service Directory,” “Access Global Directory,”

“Access State Directory,” or “Access Metro City Directory” the system will then proceed to locate the end users specific listing information by ‘Region,’ and ‘Type’ Directory queries. This is the same process displayed in queries on home units. Note:

The “Emergency” numbers on this screen will be local based upon terminal location. Below is an example of a Main Menu that may appear on a unit located in a foreign terminal. The regional directories that are offered my vary based upon location and sponsoring service provider. An end user will use the “Toggle Switch” to scroll through the list of countries. Once a country is selected, the system will provide a list of cities for the end user to choose from. Once the area for the listing is identified, the system will request the end user to make a selection from the Type Menu. Again, if the complete name is not known, simply entering a single letter will be sufficient to pull that particular section of the directory.

### Main Menu On An Wireless Directory Unit In A Foreign Port Terminal

Region Menu will be displayed first
The Type Menu will then be displayed
Enter the name of business, if not known enter the first letter only

### Listing Located

### Locating An Additional Listing From A Foreign Terminal

To initiate the task of locating an additional listing while operating form a unit located in a foreign terminal; the “Reset” button must be used to return to the Main Menu before an additional Directory database can be viewed. Once the “Reset” button is pressed, the system will automatically deduct a listing form the purchase amount. A deduction will also occur if the end user changes the letter in the letterbox at the top of the screen. Changing the letterbox in the screen ultimately changes the section in the directory. Fore example, if the letter [P] is selected, after scrolling down through headings such as Painters, Parts, and Piano Repairs, the end user will eventually discover ‘Pizza.’ The deduction will automatically appear in the top right corner of the LCD screen.
After highlighting the letterbox and selecting [P], the screen will display the P section of the Business Directory for Algeria.
The section of the directory for [P] has been displayed and an automatic deduction has occurred.
The end user has pressed the “Reset” button and located a Residential Directory for Ohio from the Main

### Menu

### Access Home Unit From A Foreign Terminal

The Main Menu on every unit in a foreign terminal will enable the end user to access their home unit. Home unit access will appear as an option on the LCD screen. After passing security verifications, the end user can proceed to view, encode, or delete private e-mail or telephone listings into the customized, Personal Directories contained in the end users home unit. The remaining Main Menu selections may vary on a foreign terminal unit dependent upon service provider and location. All of the options on this menu can be tailored to fit the exact terminal location.
When the end user selects “Access Home Unit Directory” the security provisions will begin by asking the end user to enter the home telephone number where the end unit is located. The system will then verify the end users home telephone number. Upon verification by the end user, the system will then ask that an alphabetical code name be given by the end user before to gaining access to the end users home unit. The code name can be up to 15 spaces long. After it is successfully entered, the end user would select “END” to submit the name into the system. The system will then request the security number for the end users unit. Upon successful verification, a short greeting then the main menu will appear. The system will also inform the end user if access is denied in the bottom right corner. Once access is gained, the steps on the main menu would be the same as those in the initial at home usage dependent upon the task selected.

### Main Menu On A Foreign Terminal Accessing End Users Home Unit

Must enter home telephone number in order to locate the unit.
Telephone number verification to avoid calling the wrong location.
End user must enter the correct alphabetical code name for the Security System
The security pin will then be required and verified
Upon successful verification by the Security System access is permitted.
The Main Menu of the end users home unit will appear on the screen of the Wireless Directory Unit. Once the user enters home unit, listing locations are free.

### Directory Service Providers Control

### Directory Service Providers Control

Ultimately the Directory Service Provider will control listing access for the end user. Directory Service Providers can transfer, block, limit, and monitor access to specified databases to the end users. End users can purchase access to databases containing frequently used listings by specific geographical areas. The database combinations that an end user may purchase are endless, and tailored to the specific needs of the end users for that particular unit. For example, a businessman may want to purchase a directory database for Japan to satisfy his business needs. He may also need to include a directory database for his family and friends that reside in Mexico. It would be possible for this man to purchase two database directories, one for China, and one for Mexico.
The variety of ways that a service provider packages directory services is also endless While purchasing a directory for an entire country is possible, it may be more practical, and perhaps cheaper, for some end users to purchase a directory for particular state or city. It is also possible to purchase simply by individual listing viewed. This would be ideal for someone who normally does not use directory assistance much at all. Finally, the Directory Service Provider could provide a one-time fee for a year of unlimited viewing access to all databases offered by the provider. Charges will also vary dependent upon whether the information is downloaded or viewed only.
The system contains a code that enables the end users to identify exactly which directories the customer has access to. The code can be viewed under all of the ‘Region’ and ‘Type’ subheadings. Purchased areas will display an (*) indicating access to listings in a subscribed area. (NA) will appear to indicate that the end user has not subscribed to this location, and therefore, has restricted access to the listings in this location. Restricted access to a particular database can be lifted at anytime be calling directory assistance.
To Select Connecticut or Georgia: Press “Enter” key. Delaware and Florida cannot be accessed.
The LCD screen below shows the end user that Alaska is an available directory.
When not in use for more than 15 minutes, the system will automatically kick back to default settings.

### Additional Special Features

The PDIal Directory Operating System may run on units' that have screens that vary in size. The Digital Telephone Directory System is applicable to nearly every type of business, or residential Digital telephone. An end user would be most likely to use this particular unit for their home or office setting. The exact placement of the LCD screen on these models will be on the top of the telephones interface although the size and the positioning of the screen may vary according to type of telephone model, and manner of usage. The Wireless Directory Unit, which operates as single unit, is more likely to be placed in directory ports to accommodate the high-end usage by travelers and those that are away from home. Although it is ideal for the residential setting, its' design is perfectly suited for a pay per use device, and would be commonplace to find this unit assisting the payphone. The screen design and location on this particular unit should stay uniform so as not to confuse the end users. The type and capacity of the unit purchased by the end user would be dependent upon the amount of money one is willing to spend, and the manner for which it will be used. The resolution and size of the screen is more likely to be better on some of the higher priced models. A Directory Service Provider could assist the end user in selecting a unit tailored to meet their budget and needs. Regardless of which unit is selected, The PDIal Directory Operating System works the same in both units, and on any screen size. The major difference will be that a larger screen will enable the end users to place full color advertisements in the White pages and other appropriate directories.
The Special Features of the PDIal Directory Operating system is compatible to the advertisements located within both units as well. The highlighter will work on these ads to enable the end user to access the Autodial and Map features. Large colorful maps are a great way to enable an end user to locate a newly found business, or agency. This feature is exceptionally helpful for those end users who are visually impaired and cannot read the small print of a telephone book. In addition, the operating system is an absolute necessity for those who may not have Internet access.
It is important to note that an end user change the listing heading in the directory that is being searched by simply changing the letter of the alphabet that is located on the top of the LCD screen, the same as when operating in the other directories. Using the example below, the end user would highlight the capital (P), and then press the “Enter” key. Next, the end user would use the “Toggle Switch” to scroll left and right through the alphabet until reaching the desired letter of the alphabet. Once the letter is selected, the ‘Enter’ key will submit the request and pull of the listings contained in the directory for that particular letter.

### LCD Screens

The LCD screen for the Digital Telephone Directory System will tend to be square as opposed to the long rectangular shaped screen located on the Wireless Telephone Directory Unit. The drawings show examples of “Scratch Pad” and “Locating a Listing” “Advertisement” “Locate a Listing,” and “Map” on the screen of an Digital Telephone Directory System.

### Larger LCD Screens

Next in the drawings is a view of a full color advertisement shown on an active matrix display screen. Notice at the bottom of the screen, that the address for the pizza shop is highlighted. When the end user presses the ‘Enter’ key the LCD will then display a directional map for the pizza shop. The end user will use the ‘Toggle Switch’ and the ‘Zoom’ in on specified areas of the map.
As with the single wireless unit, the Digital Telephone Directory System will display time, and an advertisement on a larger LCD screen when the unit is not in use, as shown in the Figure labeled Default Setting.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention as claimed are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A wireless directory unit and system for providing contact information on demand of a user, comprising
a small portable device with a display screen, re-writable non-volatile memory, and a controller;
CDMA transmitting and receiving apparatus;
a directory service in communication by CDMA with the wireless directory unit and system; and
a control program.
